(19) United States
(12) Patent Application Publication
(10) Pub. No.: US 2022/0400909 A1
(43) Pub. Date: Dec. 22, 2022

(54) DISPENSER WITH CAPABILITY TO DISPENSE TISSUE PRODUCTS OF MORE THAN ONE VARIANT

(71) Applicant: KIMBERLY-CLARK WORLDWIDE, INC., Neenah, WI (US)

(72) Inventors: Andrew M. Long, Appleton, WI (US); Joseph P. Fell, Kaukauna, WI (US); Jonathan D. Boulos, Appleton, WI (US); Jose A. Corella, III, Lewisville, TX (US); Abena Wojciehowski, Somerset, NJ (US); Daryl Steven Bell, Appleton, WI (US)

(73) Assignee: KIMBERLY-CLARK WORLDWIDE, INC., Neenah, WI (US)

(21) Appl. No.: 17/763,690

(22) PCT Filed: Sep. 25, 2020
(86) PCT No.: PCT/US20/52628

§ 371 Date: Mar. 25, 2022

Related U.S. Application Data
(60) Provisional application No. 62/906,201, filed on Sep. 26, 2019.

(51) Int. Cl. A47K 10/36; B31F 1/00

(52) U.S. Cl. CPC A47K 10/36; B31F 1/00; A47K 2010/3273

(57) ABSTRACT

A dispensing system can include a dispenser. The dispenser can include a dispenser housing configured to hold a supply of substrate. The dispensing system can include an actuation mechanism configured to provide a length of substrate as a tissue product. The dispensing system can be configured to produce and dispense tissue products of more than one variant. The more than one variant of tissue products can be distinguished from one another by at least one characteristic of the tissue products. The dispensing system can be configured to dispense a tissue product of a particular variant of the more than one variant of tissue products based on input independent of user interaction with the dispensing system.

### TECHNICAL FIELD

The present disclosure relates to dispensers that can dispense tissue products. More specifically, the present disclosure relates to dispensers that can dispense tissue products of more than one variant.

### BACKGROUND OF THE DISCLOSURE

People use tissue products in a variety of situations to wipe, clean, and/or dry a variety of surfaces, both animate and inanimate. Certain situations may require different amounts of tissue products, and/or may benefit from different types of tissue products. As an example, users frequently employ wet wipes in helping to wipe messes from a wearer that is wearing an absorbent article, such as body exudates, when changing the absorbent article from the wearer. Depending on the type of exudate and/or the user during such a change, the user may wish to utilize different types and/or amounts of tissue products.

Tissue products, however, are often provided in bulk offerings. Thus, users may be left with the decision of having to acquire and maintain various different tissue product offerings available for use for different situations, or more commonly, to purchase a single tissue product variant to use for various different types of wiping and/or cleaning situations. This may result in the user having less than optimal wiping and/or cleaning in some situations.

Additionally, in some wiping and/or cleaning situations, the user may not have both hands available, making the dispensing of a tissue product difficult. In some situations, the user may have hands that are soiled and in trying to dispense tissue products, may end up touching some aspect of the tissue dispenser or supply of the tissue themselves, which may result in soiling the dispenser and/or other tissue products and may result in further cleaning tasks for the user or disposing of adjacent tissue products that became soiled.

Some dispensers seek to address one or more of problems addressed above, however, they still have drawbacks. For example, some dispensers allow for tissue products to be dispensed based upon a user waving their hand in front of a motion sensor. Such a dispenser, however, is not capable of providing different tissue products that may be more desirable for the situation at hand. Other dispensers may allow a user to select various tissue products or variants, however, users are still required to interact with the dispenser to do so, and may not have the ability to interact with the dispenser based on the particular wiping and/or cleaning situation.

Thus, there is a desire for a dispenser and dispensing system that can provide more than one variant of a tissue product. There is also a desire for a dispenser and dispensing system that can provide tissue products without a need for user interaction with the dispensing system.

### SUMMARY OF THE DISCLOSURE

In one embodiment, a dispensing system is provided. The dispensing system can include a dispenser comprising a dispenser housing configured to hold a supply of substrate. The dispensing system can also include an actuation mechanism configured to provide a length of substrate as a tissue product. The dispensing system can be configured to produce and dispense tissue products of more than one variant. The more than one variant of tissue products can be distinguished from one another by at least one characteristic of the tissue products. The dispensing system can be configured to dispense a tissue product of a particular variant of the more than one variant of tissue products based on input independent of user interaction with the dispensing system.

In another embodiment, a dispenser is provided. The dispenser can include a dispenser housing configured to hold a supply of substrate. The dispenser can further include an actuation mechanism configured to provide a length of substrate as a tissue product. The dispenser can be configured to produce and dispense a first tissue product of a first variant based on a first input and can be configured to produce and dispense a second tissue product of a second variant based on a second input. The first tissue product of the first variant can differ from the second tissue product of the second variant in at least one characteristic of the first tissue product and the second tissue product. The first input can be different from the second input. The first input and the second input can each be independent of user interaction with the dispenser.

In yet another embodiment, another dispensing system is provided. The dispensing system can include a dispenser including a dispenser housing configured to hold a supply of substrate. The dispensing system can also include a sensor configured to communicate with the dispenser. The sensor can be configured to monitor a condition of a product or an environmental condition near the dispenser to provide a sensor input. The dispensing system can further include a processor configured to communicate with the sensor and to receive and analyze the sensor input and to provide a dispensing input. The dispensing input can be independent of user interaction with the dispensing system and based on the sensor input. The dispensing system can additionally include an actuation mechanism configured to provide a length of the substrate as a tissue product. The dispensing system can be configured to produce and dispense tissue products of more than one variant. The more than one variant of tissue products can be distinguished from one another by at least one characteristic of the tissue products. The dispensing system can be configured to produce and dispense a tissue product of a particular variant of the more than one variant of tissue products based on the dispensing input.

### BRIEF DESCRIPTION OF DRAWINGS

A full and enabling disclosure thereof, directed to one of ordinary skill in the art, is set forth more particularly in the remainder of the specification, which makes reference to the appended figures in which:

FIG. 1 is a top, front, right perspective view of an exemplary dispenser according to the disclosure.

FIG. 2 is a cross-sectional image taken along line 2-2 from FIG. 1.

FIG. 3 is a top perspective view of an absorbent article in an unfastened, relaxed condition.

FIG. 4 is a top, front, right perspective view of an alternative dispenser.

Repeat use of reference characters in the present specification and drawings is intended to represent the same or analogous features or elements of the disclosure.

### DETAILED DESCRIPTION OF THE DISCLOSURE

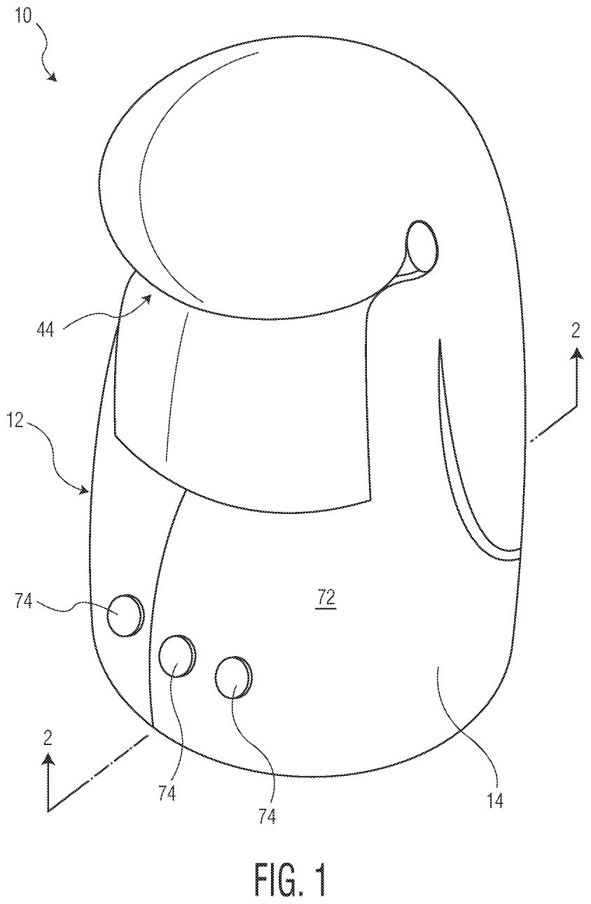

In an embodiment, the present disclosure is generally directed towards dispensing systems 10, such as that illustrated in FIGS. 1, 2, and 4, configured for dispensing tissue products 26 of more than one variant based on input independent of user interaction with the dispensing system 10. Such a dispensing system 10 can provide a user with a tissue product 26 of a particular variant that is particularly suited for the task in which the user is employing the tissue product 26. The dispensing system 10 as described herein can also provide such a tissue product 26 without the user interacting with the dispensing system 10 itself, such as touching a feature of the dispenser 12, or waving their hand by the dispenser housing 14.

Each example is provided by way of explanation and is not meant as a limitation. For example, features illustrated or described as part of one embodiment or figure can be used on another embodiment or figure to yield yet another embodiment. It is intended that the present disclosure include such modifications and variations.

When introducing elements of the present disclosure or the preferred embodiment(s) thereof, the articles “a”, “an”, “the” and “said” are intended to mean that there are one or more of the elements. The terms “comprising”, “including” and “having” are intended to be inclusive and mean that there may be additional elements other than the listed elements. Many modifications and variations of the present disclosure can be made without departing from the spirit and scope thereof. Therefore, the exemplary embodiments described above should not be used to limit the scope of the invention.

### Definitions

The term “absorbent article” refers herein to an article which may be placed against or in proximity to the body (i.e., contiguous with the body) of the wearer to absorb and contain various liquid, solid, and semi-solid exudates discharged from the body. Such absorbent articles, as described herein, are intended to be discarded after a limited period of use instead of being laundered or otherwise restored for reuse. It is to be understood that the present disclosure is applicable to various disposable absorbent articles, including, but not limited to, diapers, diaper pants, training pants, youth pants, swim pants, feminine hygiene products, including, but not limited to, menstrual pads or pants, incontinence products, medical garments, surgical pads and bandages, other personal care or health care garments, and the like without departing from the scope of the present disclosure.

The term “bonded” or “coupled” refers herein to the joining, adhering, connecting, attaching, or the like, of two elements. Two elements will be considered bonded or coupled together when they are joined, adhered, connected, attached, or the like, directly to one another or indirectly to one another, such as when each is directly bonded to intermediate elements. The bonding or coupling of one element to another can occur via continuous or intermittent bonds.

The term “communicate” means that a component is configured to communicate with another component through the same circuit, and can include communication by wire or wireless means, such as infrared (IR), radio frequency (RF), Bluetooth, Wi-Fi, cellular, light, or any other suitable communication means.

The term “nonwoven” refers herein to materials and webs of material which are formed without the aid of a textile weaving or knitting process. The materials and webs of materials can have a structure of individual fibers, filaments, or threads (collectively referred to as “fibers”) which can be interlaid, but not in an identifiable manner as in a knitted fabric. Nonwoven materials or webs can be formed from many processes such as, but not limited to, meltblowing processes, spunbonding processes, carded web processes, etc.

The term “tissue product” refers to products made from tissue webs and includes, but is not limited to, wipes (including baby wipes, flushable wipes, hands and face wipes, chemical wipes etc.), bath tissues, facial tissues, paper towels, industrial wipers, foodservice wipers, napkins, and other similar products, and can include any natural and/or synthetic fibers suitable for the end use. Tissue products as described herein can be dry or wet.

The term “user” refers herein to one who uses the dispensing system. In the context where the dispensing system is utilized with a sensor that is sensing a condition of an absorbent article, a “user” can be a caregiver who changes the absorbent article, such as, but not limited to, a diaper, diaper pant, training pant, youth pant, incontinent product, or other absorbent article about the wearer of one of these absorbent articles. A user and a wearer can be one and the same person in some situations.

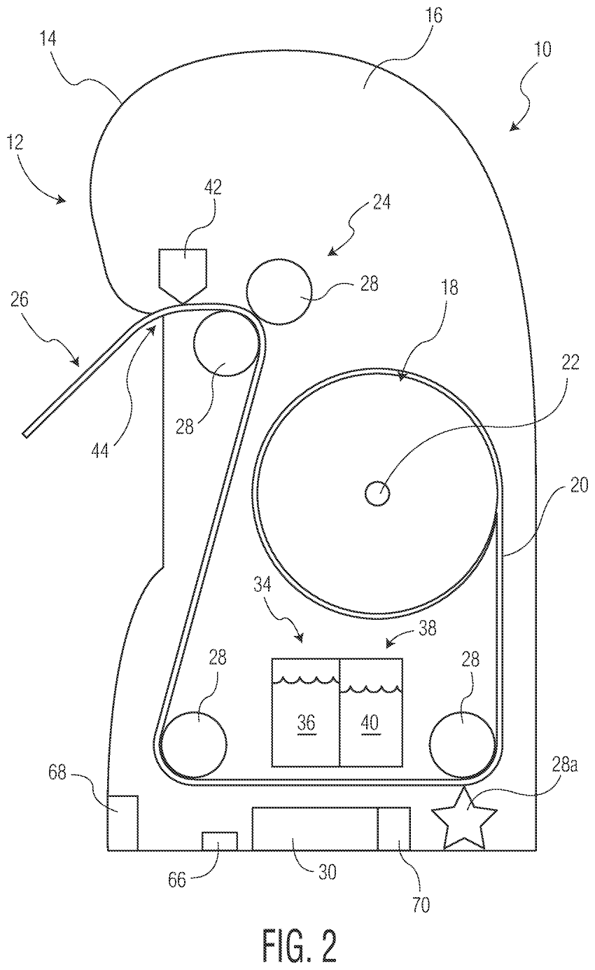

FIGS. 1 and 2 illustrate one exemplary embodiment of a dispensing system 10. The dispensing system 10 can include a dispenser 12, including a dispenser housing 14. The dispenser 12 can be in a variety of configurations, shapes, or sizes. In one embodiment, the dispenser 12 can be anthropomorphic, such as illustrated in FIG. 1. The dispenser housing 14 can include an interior space 16 and can be configured to hold a supply 18 of substrate 20. In some embodiments, the supply 18 of the substrate 18 can be in a rolled configuration, such as illustrated in FIG. 2. In such embodiments, the supply 18 of the substrate 20 can be configured to fit on a spool 22. The supply 18 of the substrate 20 can be dry, or in some embodiments, can be pre-moistened. In embodiments in which the supply 18 of the substrate 20 is pre-moistened, the dispenser housing 14 can be configured to maintain the moisture of the supply 18 of the substrate 20. In some configurations where the supply 18 of the substrate 20 is pre-moistened, the substrate 20 may include temporary wet strength additives and/or ionic sensitive salt dispersant chemistries that provide adequate strength to the substrate 20 for dispensing as a tissue product 26 and for use, but can provide a tissue product 26 that is dispersible in freshwater in a toilet and sewer system.

Although not shown in FIG. 2, it is contemplated that the dispensing system 10 and the dispenser housing 14 can be configured to hold more than one supply 18 of substrate 20. In such an embodiment, a first supply 18 of substrate 20 can differ from a second supply 18 of substrate 20, for example, such as having a different fiber composition, basis weight, or other characteristic.

The supply 18 or supplies of substrates 20 can vary depending on the particular tissue product 26 being produced and or dispensed by the dispensing system 10. The substrates 20 as used herein can also be of various configurations, such as single ply or two or more plies. Each ply can include one or more layers, as desired. Additionally, the substrates 20 can include various fibers and/or blends of fibers, including natural fibers and/or synthetic fibers. In some embodiments, the substrate 20 can include biodegradable or compostable fibers, including, but not limited to fibers including Polycaprolactone, Polylactic acid (PLA), Polyhydroxyalkanoates, Polybutylene succinate, and polybutylene adipate terephthalate. In some embodiments, such fibers can be staple fibers or can be meltspun fibers.

The dispenser system 10 can also include an actuation mechanism 24 to provide a length of substrate 20 as a tissue product 26. In some embodiments, the actuation mechanism 24 can be configured to dispense a length of the supply 18 of the substrate 20 as a tissue product 26. The actuation mechanism 24 can be, in some embodiments, one or more rollers 28 that transfer the supply 18 of the substrate 20. In some embodiments, one or more of the rollers 28 can be a drive roller and one or more other rollers can be idler rollers. It is contemplated that the actuation mechanism 24 can include additional or alternative equipment to transfer and dispense such a tissue product 26 as is known in the art. In some embodiments, the actuation mechanism 24 can provide “touch-free” dispensing of a tissue product 26 to a user. However, in some embodiments, the actuation mechanism 24 can merely facilitate the dispensing of a tissue product 26 in that the dispensing system 10 allows a user to grasp a portion of the supply 18 of the substrate 20 to pull the substrate away from the dispenser 12 as a tissue product 26. For example, the actuation mechanism 24 can be a series of rollers 28 that allows a user to pull on the supply 18 of the substrate 20 to dispense the tissue product 26.

The dispensing system 10 can be configured to produce and to dispense tissue products 26 of more than one variant. Tissue products of different variants can be distinguished from one another by at least one characteristic of the tissue products 26. Characteristics of the tissue products 26 that can distinguish one variant from another can include, but are not limited to: length, moisture content, wetting composition, surface topography/texture (e.g., rough, smooth, rippled, etc.), temperature (e.g., heated or cooled), basis weight, fiber composition, number of plies, and number of layers in each ply. As an example, a first tissue product 26 of a first variant can have a first length, and a second tissue product 26 of a second variant can have a second length, where the first length is not equal to the second length. As another example, a first tissue product 26 of a first variant can include a first wetting composition 36, and a second tissue product 26 of a second variant can include a second wetting composition 40, where the first wetting composition 36 is different from the second wetting composition 40. It is to be appreciated that there are a variety of different characteristics, some of which are listed above, that can provide a tissue product 26 of a first variant that is different from a tissue product 26 of a second variant.

The dispensing system 10 can be configured to produce and to dispense a tissue product 26 of a particular variant of tissue product 26 based on input independent of user interaction with the dispensing system 10. In other words, the dispensing system 10 can be configured to produce and dispense a tissue product 26 without the user being required to interact with the dispensing system 10, such as, for example, waiving their hand by the dispensing system 10 in order to produce and dispense a tissue product 26, or pressing a component of the dispensing system 10 to activate the dispensing system 10 to dispense a tissue product 26. This is a beneficial aspect of the dispensing system 10 because users in need of a tissue product 26 to wipe and/or clean a surface may not always have a free hand to interact with the dispensing system 10, or their hands may be soiled such that interacting with the dispensing system 10 would not be desirable.

In preferred embodiments, the dispensing system 10 can include a processor 30 that is configured to communicate with the actuation mechanism 24. As illustrated in FIG. 2, the processor 30 can be disposed within the dispenser housing 14 in some embodiments. However, it can be appreciated that the processor 30 can be disposed in a remote location away from the dispenser housing 14 and/or can be part of another device (such as a user's smartphone, tablet, etc.), yet still communicate with the actuation mechanism 24. In some embodiments, the processor 30 can be configured to communicate with a sensor 32.

The processor 30 can process via various computing types/methods, including edge-computing, fog-computing, and/or cloud computing. As such, processing by the processor 16 can take place at the edge (e.g., locally), near the edge (e.g., a gateway or nearby computing device), or in the cloud (e.g., public, private, hybrid).

A sensor 32 that can be in communication with the processor 30 of the dispensing system 10 can be of various types and perform various sensing functions. In one preferred embodiment, the sensor 32 can be configured to monitor a condition of a product or an environmental condition near the dispenser 12. The sensor 32 can provide a sensor input to the dispensing system 10, such as by providing the sensor input to the processor 30. The processor 30 can be configured to receive and analyze the sensor input from the sensor 32 in order to provide an input independent of user interaction with the dispensing system 10 based on the sensor input to the dispensing system 10 to dispense a tissue product 26 of a particular variant. As will be described in further detail below, the processor 30 can interpret the sensor input from the sensor 32 and provide a dispensing input to one or more components of the dispensing system 10 to produce and to dispense a tissue product 26 of a particular variant. Thus, the dispensing system 10 can produce a tissue product 26 of a particular variant that may be suited for a user based on a potential need of a user.

In some embodiments, the dispensing system 10 can further include a first supply 34 of a first wetting composition 36. In some embodiments, the dispensing system 10 can further include a second supply 38 of a second wetting composition 40. The second wetting composition 40 can be different from the first wetting composition 36. As an example, the first wetting composition 36 can be a wetting composition for applying to a substrate 20 from the supply of substrate 18 to provide a first baby wipe product (such as Huggies® Refreshing Clean Wipes™) and the second wetting composition 40 can a wetting composition for applying to a substrate 20 from the supply of substrate 18 to provide a second baby wipe product (such as Huggies® Nourish & Care Wipes™). Thus, in embodiments including a supply 34, 38 of different wetting compositions 36, 40, the dispensing system 10 can provide different tissue products with wetting compositions that may be more desirable for the user based on the particular cleaning or wiping task. In some embodiments, one or more of the supply 34, 38 of the wetting compositions 36, 40 can be heated above ambient temperature or cooled below ambient temperature by any suitable equipment. By having heated and/or cooled wetting compositions 36, 40 that can be applied to the substrate 20, the dispensing system 10 can provide different temperature characteristics to a tissue product 26, which may be advantageous for a user of the dispensing system 10.

In some embodiments, the dispensing system 10 may include at least one roller 28a that can be activated to generate a topography modification to the substrate 20. For example, the roller 28a illustrated in FIG. 2 may generate a particular embossing pattern on the substrate 20 as it is transferred through the dispenser housing 14. The roller 28a can be a feature that is employed to the substrate 20 as part of transferring the substrate 20 for every tissue product 26, or this feature can be selectively activated through communication with the processor 30 based on various sensed conditions, data, or user input. For example, the processor 30 can be configured to provide a dispensing input to move the roller 28a to engage with the substrate 20 in certain circumstances to provide a topography modification to the substrate 20.

As illustrated in FIG. 2, the dispensing system 10 can also include a cut-off mechanism 42. The cut-off mechanism 42 can cut or perforate the substrate 20 to a particular length based on input from the processor 30 to provide a discrete tissue product 26 for the user of a particular length. The processor 30 can provide a dispensing input to the cut-off mechanism 42 to cut or perforate the substrate 20 to provide a tissue product 26 with a first length in some situations, and can provide a dispensing input to the cut-off mechanism 42 to cut or perforate the substrate 20 to provide a tissue product with a second length in other situations. The processor 30 can provide such dispensing inputs to the cut-off mechanism 42 based on sensed conditions, data, or user input. In some embodiments, the cut-off mechanism 42 can provide an edge such that when the user pulls on the substrate near the opening 44 in the dispenser housing 14 the user severs the substrate 20 to provide a discrete tissue product 26.

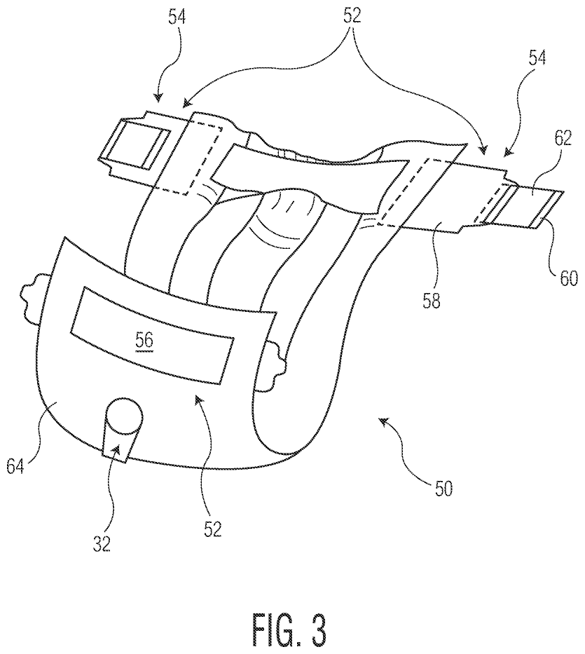

As discussed above, the dispensing system 10 of the present disclosure may be configured to communicate with a sensor 32 that is configured to monitor a condition of a product. In one preferred embodiment, the sensor 32 can be configured to monitor a condition of an absorbent article 50, such as a diaper illustrated in FIG. 3. The absorbent article 50 can include a fastening system 52. FIG. 3 depicts an absorbent article 50 that is currently in a relaxed, unfastened condition. Although the absorbent article 50 displayed in FIG. 3 is an open diaper, the dispensing system 10 and sensor 32 as described herein could be used with a variety of other products, including, but not limited to, other embodiments of the absorbent articles including, but not limited to, training pants, youth pants, adult incontinence garments, and feminine hygiene articles. The fastening system 52 of the absorbent article 50 can be configured to secure the absorbent article 50 about the waist of the wearer while the product is being used. The fastening system 52 can include one or more back fasteners 54 and one or more front fasteners 56. As illustrated in FIG. 3, the absorbent article 50 can include two back fasteners 54 and one front fastener 56, however, other variations could be employed in a fastening system 52. The back fasteners 54 can include one or more materials bonded together to form a composite ear as is known in the art. For example, the composite fastener may be composed of a main ear component 58 (which can demonstrate elastic properties), a nonwoven carrier or base 60, and a fastening component 62 (as labeled on the right, back fastener in 54 in FIG. 3). In a packaged condition, the fastening component 62 may engage the main ear component 58, as shown in the left, back fastener 54 in FIG. 3. The fastening component 62 can be, in some embodiments, a hook material that engages with a loop material that can form the front fastener 56. Additionally or alternatively, the fastening component 62 can include a tape material that engages with the front fastener 56. It is to be understood that the front fastener 56 may be a discrete component on the outer cover 64 of the absorbent article 50, or may be a portion of the outer cover 64 itself.

When the fastening component 40 of each of the back fasteners 32 is engaged with the front fastener 34, the absorbent article 34 can be in the fastened conditioned and secured about the waist of the wearer. However, when the absorbent article 20 is insulted with body exudates it can be desired to replace the used absorbent article 20 with a new absorbent article 20, which may frequently be changed near the dispenser 12 of the dispensing system 10, such as near a changing table or other area where a caregiver or user may frequently change absorbent articles from the wearer.

The dispensing system 10 as described herein can communicate with the sensor 32. As one example, the sensor 32 can be configured to monitor a condition of an absorbent article 50 that includes monitoring for a presence of an exudate in the absorbent article 50. In some embodiments, the sensor 32 can be configured to distinguish between a type of exudate, for example, such as between urine and bowel movement exudates. One exemplary sensor 32 that can be utilized to monitor for a condition of an absorbent article 50 can be a capacitance-based detector, such as disclosed in U.S. Pat. No. 8,866,624 issued to Thomas Michael Ales, III et al., or an induction-based detector, such as disclosed in U.S. Pat. No. 8,207,394 issued to Joseph Raymond Feldkamp et al., or an infra-red-based detector, such as disclosed in U.S. Pat. App. Pub. No. 2010/0168694 by Sudhanshu Gakhar et al, each of which is hereby incorporated by reference to the extent such does not contradict with the present disclosure. Of course, it is to be appreciated that other types of sensors 32 that can detect body exudates, such as volatile organic compound (VOC) sensors, as well as sensors 32 configured for sensing characteristics other than characteristics of absorbent articles 50 may be configured to communicate with the dispensing system 10 discussed herein.

In this example of monitoring for a presence of exudates of an absorbent article 50, the sensor 32 can provide a sensor input to the dispensing system 10, such as by providing the sensor input to the processor 30. An exemplary sensor input can be that the sensor 32 has sensed the presence of urine in the absorbent article 50. Another exemplary sensor input can be that the sensor 32 has sensed the presence of a bowel movement in the absorbent article 50. The processor 30 can be configured to receive and analyze the sensor input from the sensor 32 in order to provide an input independent of user interaction with the dispensing system 10 based on the sensor input to the dispensing system 10 to dispense a tissue product 26 of a particular variant. For example, upon receiving a sensor input from the sensor 32 that the sensor 32 has detected the presence of a bowel movement in the absorbent article 50, the processor 30 may analyze such a sensor input and may provide one or more dispensing inputs to one or more components of the dispensing system 10 to provide a tissue product 26 of a particular variant that is advantageous for cleaning and/or wiping the skin of a wearer having a bowel movement. This may include the processor 30 providing a dispensing input to the actuation mechanism 24 to transfer a first length of substrate 20 of the supply of substrate 18 that is of greater length than is typically used for wiping or cleaning situations involving an absorbent article 50 that may include urine. Other potential dispensing inputs to the dispensing system 10 that the processor 30 may provide can include, but are not limited to, dispensing inputs to actuate an amount of either/or both of the first wetting composition 36 from the supply 34 of the first wetting composition 36 and the second wetting composition 40 from the supply 38 of the second wetting composition 40 to the substrate 20 being transferred and that may be advantageous for wiping and/or cleaning the skin of a wearer with an absorbent article 50 including a bowel movement. Another potential dispensing input to the dispensing system 10 that the processor 30 may provide can include providing a dispensing input to actuate a roller 28a to engage the substrate 20 and provide a topography to the substrate 20 that may be more beneficial for wiping and/or cleaning the skin of a wearer with an absorbent article 50 including a bowel movement. As can be seen from this discussion, the dispensing system 10 is thus capable of providing a tissue product 26 of more than one variant to the user, and may be particularly suited to a user's potential need, based on an input that is independent of user interaction with the dispensing system 10 itself.

The dispensing system 10 can include further features to help ensure that a tissue product 26 is being produced and/or dispensed at the proper time that a user may need the tissue product 26 produced and/or dispensed. For example, the dispensing system 10 can include a proximity sensor 66 (as illustrated in FIG. 2) to determine if a user and/or wearer having an absorbent article including a sensor 32 is approaching the dispenser 12. Such a proximity sensor 66 can provide a proximity sensor input to the processor 30. The processor 30 can be configured to receive and analyze such a proximity sensor input, or lack thereof, in determining whether and when to provide dispensing inputs to various components of the dispensing system 10 to produce and/or dispense a tissue product 26 of a particular variant. For example, the processor 30 can be configured to wait to receive a proximity sensor input from the proximity sensor 66 after receiving a sensor input from the sensor 32 of a particular condition before the processor 30 will provide a dispensing input to one or more components of the dispensing system 10 to produce and/or dispense a tissue product 26 of a particular variant. Configuration of the processor 30 in this manner can help ensure that the tissue product 26 of the particular variant is being produced and/or dispensed at a proper time when the user is looking to utilize such a tissue product 26.

In some embodiments, the dispensing system 10 can include an auditory capture mechanism 68 and memory device 70 for storing an acoustic signature model, such as described in WO2019/0126131 by Andrew M. Long, et al., which is hereby incorporated by reference to the extent it does not contradict with the present disclosure. The auditory capture mechanism 68 can be configured to capture potential use sound profiles, such as the sound profile of a fastening component 62 of a back fastener 54 disengaging from the front fastener 56, and compare such potential use sound profile to an acoustic signature model to determine if the potential use sound profile captured by the auditory capture mechanism 68 meets, or sufficiently corresponds to at a particular confidence level, a stored acoustic signature model. This determination can help ensure that an absorbent article 50 may be in the process of being changed by a user and can be used as an additional input before the processor 30 will provide a dispensing input to one or more components of the dispensing system 10 to produce and/or dispense a tissue product 26 of a particular variant.

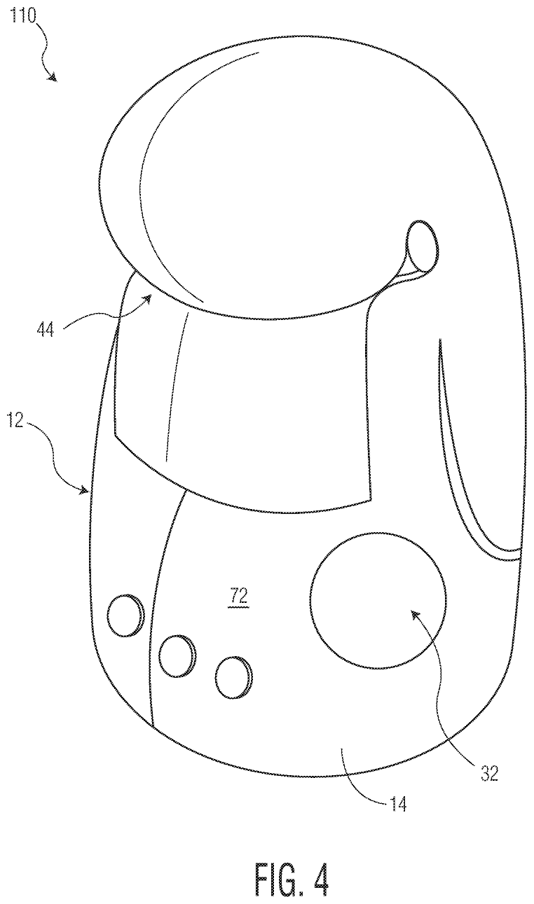

In some embodiments, a sensor 32 may alternatively or additionally be positioned near the dispenser 12 itself, as opposed to a product (such as an absorbent article 50). As discussed above, an auditory capture mechanism 68 can be on such sensor 32 that can be positioned near the dispenser 12 itself. In some embodiments, such as in the dispensing system 110 depicted in FIG. 4, a sensor 32 can be disposed on the outer surface 74 of the dispenser housing 14. Such a sensor 32 can be configured to monitor at least one environmental condition near the dispenser 12. Various environmental conditions that can be monitored and can be communicated to the processor through the sensor 32 can include, but are not limited to: temperature, presence of volatile organic compounds, sounds, and combinations thereof. Such a sensor 32 can provide alternative and/or additional sensor inputs to the processor 30 that the processor 30 can be configured to receive and analyze before providing a dispensing input to one or more components of the dispensing system 10 to produce and/or dispense a tissue product 26 of a particular variant.

Thus, it can be seen from the discussion herein that the dispensing system 10 can include one or more features to help determine when is an appropriate time to produce and/or dispense a tissue product 26 of a particular variant for a user.

In some embodiments, the dispensing system 10 can be configured to alternatively or additionally analyze an external data set as an input before providing a dispensing input to one or more components of the dispensing system 10 to produce and/or dispense a tissue product 26 of a particular variant. An external data set can include various information that is relevant to what particular variant the user may have a potential need for and is independent of any user interaction with the dispensing system 10. For example, an external data set may include information as to: what time a user typically uses a tissue product 26, what particular variants 26 have been used in the past and at what times, the number of tissue products 26 dispensed at one time, the number of dispensing failures, the amount of time between dispensing tissue products 26, the number of variants of tissue products 26 used within a designated time frame (e.g., 24 hours, 7 days, 30 days, etc.), the type of absorbent article(s) used or purchased within a household or by a purchaser, the age(s) of wearer(s) of an absorbent article, or other information that may be of particular relevance in informing what particular variant may be particularly suited to a user at a particular instance.

In some embodiments, the dispensing system 10 can also be configured to include manual inputs that can be received through a user selecting certain features for a tissue product 26. As an example, a dispenser 12 can be configured to include one or more selectable component buttons 74 that can relate to tissue product 26 characteristics, such as length, wetting composition, surface topography, etc. The selectable component button(s) 74 can be accessible on the outer surface 72 of the dispenser housing 14. The selectable component button(s) 74 may be useful for situations where the user wants to manually interact with the dispensing system 10. The dispensing system 10 can also be configured to accept manual inputs through remote means, such as through a user interface provided on a separate device (e.g., such as on an app on a user's smartphone) that is configured to communicate with the dispensing system 10 and/or forms part of the dispensing system 10.

The dispensing system 10 as described herein can provide the benefits of being configured to provide more than one variant of a tissue product based on an input independent of user interaction with the dispensing system 10. By doing so, the user can keep more attention on the wiping and/or cleaning situation at hand, and may also keep the dispenser 12 more clean by preventing unwanted touching of the dispenser 12 by a user's hands that may be soiled. Furthermore, the dispensing system 10 can provide a tissue product 26 that is particularly suited to a potential need of a user based on input that is independent of user interaction with the dispensing system 10. This can provide the user with a more effective and efficient wiping and/or cleaning and a more positive experience with the tissue products 26 capable of being dispensed by the dispensing system 10.

### EMBODIMENTS

Embodiment 1: A dispensing system comprising: a dispenser comprising a dispenser housing configured to hold a supply of substrate; and an actuation mechanism configured to provide a length of substrate as a tissue product; the dispensing system being configured to produce and dispense tissue products of more than one variant, the more than one variant of tissue products being distinguished from one another by at least one characteristic of the tissue products; and wherein the dispensing system is configured to dispense a tissue product of a particular variant of the more than one variant of tissue products based on input independent of user interaction with the dispensing system.

Embodiment 2: The dispensing system of embodiment 1, further comprising a processor, the processor configured to communicate with the actuation mechanism.

Embodiment 3: The dispensing system of embodiment 2, wherein the processor is disposed within the dispenser housing.

Embodiment 4: The dispensing system of embodiment 2 or 3, further comprising a sensor configured to communicate with the dispensing system, the sensor configured to monitor a condition of a product or an environmental condition near the dispenser to provide a sensor input to the dispensing system.

Embodiment 5: The dispensing system of embodiment 4, wherein the sensor communicates the sensor input to the processor, and wherein the processor receives and analyzes the sensor input, provides the input independent of user interaction with the dispensing system based on the sensor input to the dispensing system to dispense the tissue product of the particular variant.

Embodiment 6: The dispensing system of embodiment 4 or 5, wherein the sensor is configured to monitor a condition of a product.

Embodiment 7: The dispensing system of embodiment 6, wherein the product is an absorbent article.

Embodiment 8: The dispensing system of embodiment 7, wherein the condition of the absorbent article being monitored is indicative of a presence of an exudate in the absorbent article.

Embodiment 9: The dispensing system of embodiment 8, wherein the sensor is configured to distinguish between a type of exudate.

Embodiment 10: The dispensing system of any one of embodiments 4-6, wherein the sensor is configured to monitor at least one environmental condition near the dispenser.

Embodiment 11: The dispensing system of embodiment 10, wherein the at least one environmental condition is selected from the group consisting of: temperature, presence of volatile organic compounds, sounds, and combinations thereof.

Embodiment 12: The dispensing system of embodiment 10 or 11, wherein the sensor is disposed on an outer surface of the dispenser housing.

Embodiment 13: The dispensing system of any one of the preceding embodiments, wherein the input independent of user interaction with the dispensing system is based on an external data set.

Embodiment 14: The dispensing system of any one of the preceding embodiments, further comprising a first supply of a first wetting composition.

Embodiment 15: The dispensing system of embodiment 14, further comprising a second supply of a second wetting composition, the second wetting composition being different than the first wetting composition.

Embodiment 16: The dispensing system of any one of the preceding embodiments, further comprising at least one roller that can be activated to generate a topography modification to the substrate.

Embodiment 17: The dispensing system of any one of the preceding embodiments, wherein the at least one characteristic of the tissue products that can distinguish tissue products of more than one variant is selected from the group consisting of: length, moisture content, wetting composition, surface topography, temperature, basis weight, fiber composition, number of plies, and numbers of layers in each ply.

Embodiment 18: The dispensing system of any one of the preceding embodiments, further comprising the supply of substrate.

Embodiment 19: A dispenser comprising: a dispenser comprising a dispenser housing configured to hold a supply of substrate; and an actuation mechanism configured to provide a length of substrate as a tissue product; the dispenser being configured to produce and dispense a first tissue product of a first variant based on a first input and configured to produce and dispense a second tissue product of a second variant based on a second input; wherein the first tissue product of the first variant differs from the second tissue product of the second variant in at least one characteristic of the first tissue product and the second tissue product, the first input is different from the second input, and the first input and the second input are each independent of user interaction with the dispenser.

Embodiment 20: A dispensing system comprising: a dispenser comprising a dispenser housing configured to hold a supply of substrate; a sensor configured to communicate with the dispenser, the sensor configured to monitor a condition of a product or an environmental condition near the dispenser to provide a sensor input; a processor configured to communicate with the sensor and to receive and analyze the sensor input and to provide a dispensing input, the dispensing input being independent of user interaction with the dispensing system and based on the sensor input; and an actuation mechanism configured to provide a length of the substrate as a tissue product; wherein the dispensing system is configured to produce and dispense tissue products of more than one variant, the more than one variant of tissue products being distinguished from one another by at least one characteristic of the tissue products; and wherein the dispensing system is configured to produce and dispense a tissue product of a particular variant of the more than one variant of tissue products based on the dispensing input.

All documents cited in the Detailed Description are, in relevant part, incorporated herein by reference; the citation of any document is not to be construed as an admission that it is prior art with respect to the present invention. To the extent that any meaning or definition of a term in this written document conflicts with any meaning or definition of the term in a document incorporated by references, the meaning or definition assigned to the term in this written document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A dispensing system comprising:
a dispenser comprising a dispenser housing configured to hold a supply of substrate; and
an actuation mechanism configured to provide a length of substrate as a tissue product;
the dispensing system being configured to produce and dispense tissue products of more than one variant, the more than one variant of tissue products being distinguished from one another by at least one characteristic of the tissue products; and wherein the dispensing system is configured to dispense a tissue product of a particular variant of the more than one variant of tissue products based on input independent of user interaction with the dispensing system.

2. The dispensing system of claim 1, further comprising a processor, the processor configured to communicate with the actuation mechanism.

3. The dispensing system of claim 2, wherein the processor is disposed within the dispenser housing.

4. The dispensing system of claim 2, further comprising a sensor configured to communicate with the dispensing system, the sensor configured to monitor a condition of a product or an environmental condition near the dispenser to provide a sensor input to the dispensing system.

5. The dispensing system of claim 4, wherein the sensor communicates the sensor input to the processor, and wherein the processor receives and analyzes the sensor input, provides the input independent of user interaction with the dispensing system based on the sensor input to the dispensing system to dispense the tissue product of the particular variant.

6. The dispensing system of claim 4, wherein the sensor is configured to monitor a condition of a product.

7. The dispensing system of claim 6, wherein the product is an absorbent article.

8. The dispensing system of claim 7, wherein the condition of the absorbent article being monitored is indicative of a presence of an exudate in the absorbent article.

9. The dispensing system of claim 8, wherein the sensor is configured to distinguish between a type of exudate.

10. The dispensing system of claim 4, wherein the sensor is configured to monitor at least one environmental condition near the dispenser.

11. The dispensing system of claim 10, wherein the at least one environmental condition is selected from the group consisting of: temperature, presence of volatile organic compounds, sounds, and combinations thereof.

12. The dispensing system of claim 10, wherein the sensor is disposed on an outer surface of the dispenser housing.

13. The dispensing system of claim 1, wherein the input independent of user interaction with the dispensing system is based on an external data set.

14. The dispensing system of claim 1, further comprising a first supply of a first wetting composition.

15. The dispensing system of claim 14, further comprising a second supply of a second wetting composition, the second wetting composition being different than the first wetting composition.

16. The dispensing system of claim 1, further comprising at least one roller that can be activated to generate a topography modification to the substrate.

17. The dispensing system of claim 1, wherein the at least one characteristic of the tissue products that can distinguish tissue products of more than one variant is selected from the group consisting of: length, moisture content, wetting composition, surface topography, temperature, basis weight, fiber composition, number of plies, and numbers of layers in each ply.

18. The dispensing system of claim 1, further comprising the supply of substrate.

19. A dispenser comprising:
a dispenser comprising a dispenser housing configured to hold a supply of substrate; and
an actuation mechanism configured to provide a length of substrate as a tissue product;
the dispenser being configured to produce and dispense a first tissue product of a first variant based on a first input and configured to produce and dispense a second tissue product of a second variant based on a second input;
wherein the first tissue product of the first variant differs from the second tissue product of the second variant in at least one characteristic of the first tissue product and the second tissue product, the first input is different from the second input, and the first input and the second input are each independent of user interaction with the dispenser.

20. A dispensing system comprising:
a dispenser comprising a dispenser housing configured to hold a supply of substrate;
a sensor configured to communicate with the dispenser, the sensor configured to monitor a condition of a product or an environmental condition near the dispenser to provide a sensor input;
a processor configured to communicate with the sensor and to receive and analyze the sensor input and to provide a dispensing input, the dispensing input being independent of user interaction with the dispensing system and based on the sensor input; and
an actuation mechanism configured to provide a length of the substrate as a tissue product;
wherein the dispensing system is configured to produce and dispense tissue products of more than one variant, the more than one variant of tissue products being distinguished from one another by at least one characteristic of the tissue products; and wherein the dispensing system is configured to produce and dispense a tissue product of a particular variant of the more than one variant of tissue products based on the dispensing input.
